(19) United States
(12) Patent Application Publication
(10) Pub. No.: US 2026/0036934 A1
(43) Pub. Date: Feb. 5, 2026

(54) IMAGE FORMING APPARATUS

(71) Applicant: SHARP KABUSHIKI KAISHA, Osaka (JP)

(72) Inventor: SOHICHI TAKATA, Osaka (JP)

(21) Appl. No.: 19/286,715

(22) Filed: Jul. 31, 2025

(30) Foreign Application Priority Data
Aug. 2, 2024 (JP) 2024-127709

(51) Int. Cl. G03G 15/00

(52) U.S. Cl. CPC G03G 15/6511; G03G 15/6508; G03G 2215/00383; G03G 2215/0054

(57) ABSTRACT

An image forming apparatus, includes: a connecting member that connects, in an image forming device body and an extension unit allowed to be connected below the image forming device body, the image forming device body and the extension unit to each other, wherein the connecting member includes a first connecting claw that is locked to the image forming device body, and a second connecting claw that is locked to the extension unit, and includes an operation portion that switches between a locked state and an unlocked state of at least one of the first connecting claw and the second connecting claw, and the operation portion is operable in a direction in which the first connecting claw and the second connecting claw are connected to each other along the connecting member.

### CROSS-REFERENCE TO RELATED APPLICATION

The present application claims priority from Japanese Application JP2024-127709, the content to which is hereby incorporated by reference into this application.

### BACKGROUND OF THE INVENTION

### 1. Field of the Invention

The present disclosure relates to an image forming apparatus including a connecting member that connects a related device such as an extension unit.

### 2. Description of the Related Art

In the related art, there is known an image forming apparatus in which a related device such as an option feeder is easily added to an image forming device body. In the image forming apparatus in the related art, a configuration is known in which a protruding portion provided at the image forming device body is inserted into a hole of a sheet metal provided at the option feeder, and the sheet metal is displaced in a direction orthogonal to the protruding portion to slide and fix a slide lock plate.

Further, there is known a sheet feeding device and an image forming apparatus for which costs can be reduced by simplifying connection structures between sheet feeding devices added in a stacked manner and between an image forming device body and an uppermost sheet feeding device.

### SUMMARY OF THE INVENTION

The image forming apparatus in which a related device such as an option feeder can be easily added, and the sheet feeding device and the image forming apparatus for which costs can be reduced by simplifying the connection structures between the sheet feeding devices added in a stacked manner and between the image forming device body and the uppermost sheet feeding device, in the related art, are configured as described above. In the image forming apparatus in the related art, it is necessary to separately prepare the slide lock plate. In addition, in the image forming apparatus in the related art, since sheet feeding cassettes are fixed by stays that connect them in a height direction, there is a problem that screwing is essential.

The present disclosure has been made to address the above-described issue, and an object of the disclosure is to provide an image forming apparatus having a compact configuration with fewer members.

An image forming apparatus according to the present disclosure includes an image forming device body and an extension unit allowed to be connected below the image forming device body. A connecting member that connects the image forming device body and the extension unit to each other is provided, the connecting member includes a first connecting claw that is locked to the image forming device body, and a second connecting claw that is locked to the extension unit, and includes an operation portion that switches between a locked state and an unlocked state of at least one of the first connecting claw and the second connecting claw, and the operation portion is operable in a direction in which the first connecting claw and the second connecting claw are connected to each other along the connecting member.

Preferably, the operation portion includes a regulator that regulates displacement in a horizontal direction of the connecting member, and regulates the displacement in the horizontal direction of the connecting member in a state in which the connecting member connects the image forming device body and the extension unit to each other, and the regulation in the horizontal direction of the connecting member by the operation portion is released in a state in which the connection is released.

The extension unit may be integrated with the image forming device body by positioning the second connecting claw of the connecting member at a predetermined position of the extension unit, inclining, in a state in which a back surface side protruding portion of the connecting member is inserted into an opening of the extension unit, the connecting member outward with a corner portion of the connecting member as a fulcrum, disposing the first connecting claw to be locked at a predetermined position of the image forming device body, and then pushing the operation portion downward.

The image forming apparatus may include a plurality of the connecting members.

The connecting member may be attached to the extension unit, and then may be attached to the image forming device body.

According to the present disclosure, the connecting member includes the first connecting claw that is locked to the image forming device body and the second connecting claw that is locked to the extension unit, and includes the operation portion that switches between the locked state and the unlocked state of at least one of the first connecting claw and the second connecting claw, and thus it is possible to provide the image forming apparatus that has a compact configuration with fewer members and can be connected to the extension unit.

The above-described objects, other objects, features, and advantages of the present disclosure will be further obvious from the detailed description of examples given below with reference to the drawings.

### BRIEF DESCRIPTION OF THE DRAWINGS

FIG. 1 is a perspective view of an image forming apparatus to which an extension unit according to an embodiment of the present disclosure is connected, as viewed from a front surface side.

FIG. 2 is a perspective view of the image forming apparatus illustrated in FIG. 1 as viewed from a back surface side.

FIG. 3 is a perspective view of a state in which, in the image forming apparatus to which a sheet feeding cassette drawable to the front surface side is connected as an extension unit, the sheet feeding cassette is opened, as viewed from the front surface side, similarly to FIG. 1.

FIG. 4 is a perspective view of the image forming apparatus illustrated in FIG. 3 as viewed from the back surface side.

FIG. 5 is a perspective view of the sheet feeding cassette accommodated in the extension unit illustrated in FIG. 3, as viewed from above on the front surface side.

FIG. 6 is a perspective view of the front surface side of an image forming device body illustrated in FIG. 1 as viewed from below.

FIG. 7 is a perspective view of the back surface side of the image forming device body illustrated in FIG. 1 as viewed from below.

FIG. 8 is an enlarged view of a portion illustrated as a locking portion A in FIG. 6.

FIG. 9 is an enlarged view of a portion illustrated as a locking portion B in FIG. 6.

FIG. 10 is an enlarged view of a portion illustrated as a locking portion C in FIG. 7.

FIG. 11 is an enlarged view of a portion illustrated as a locking portion D in FIG. 7.

FIG. 12 is a perspective view of the back surface side of the image forming apparatus illustrating a state in which the image forming device body and the extension unit are integrated with each other by a connecting member.

FIG. 13 is an enlarged view of a portion surrounded by a circle and indicated by 13 in FIG. 12.

FIG. 14 is a diagram illustrating a state in which the connecting member is inserted into a receiving portion of the image forming device body in FIG. 13, to connect the image forming device body and the extension unit to each other by the connecting member, and both are integrated with each other.

FIG. 15 is a perspective view illustrating a configuration of the connecting member.

FIG. 16 is a perspective view of a slide member as viewed from a back surface side protruding portion side.

FIG. 17 is a diagram explaining fixing and operation of the connecting member.

FIG. 18 is a perspective view illustrating a state in which the connecting member is locked to a T-shaped main body hole and the connecting member is locked to the main body.

FIG. 19 is a perspective view of a front surface side protruding portion serving as an operation portion of the connecting member as viewed obliquely from above.

FIG. 20 is a diagram illustrating a state in which a T-shaped protruding portion of the connecting member is inserted into the main body hole of the extension unit.

FIG. 21 is a diagram illustrating a state in which the insertion of the T-shaped protruding portion of the connecting member into the main body hole of the extension unit is completed and the connecting member is integrated with the main body.

FIG. 22 is a diagram illustrating a state in which the image forming device body on an opposite side to that in FIG. 12 and the extension unit are integrated with each other by the connecting member.

FIG. 23 is an enlarged view of a portion surrounded by a circle and indicated by 23 in FIG. 22.

FIG. 24 is a diagram illustrating a state in which the image forming device body and the extension unit are connected to each other by the connecting member and both are integrated with each other.

FIG. 25 is a diagram illustrating a state in which the image forming device body and the extension unit that are on the front surface side and a left side of the image forming apparatus are integrated with each other by the connecting member.

FIG. 26 is an enlarged view of a portion surrounded by a circle and indicated by 26 in FIG. 25.

FIG. 27 is a diagram illustrating a state in which the image forming device body and the extension unit are connected to each other by the connecting member and both are integrated with each other.

FIG. 28 is a diagram illustrating a state in which the image forming device body and the extension unit that are on the front surface side and a right side of the image forming apparatus are integrated with each other by the connecting member.

FIG. 29 is an enlarged view of a portion surrounded by a circle and indicated by 29 in FIG. 28.

FIG. 30 is a diagram illustrating a state in which the image forming device body and the extension unit that are on the front surface side and the right side of the image forming apparatus are integrated to each other by the connecting member.

FIG. 31 is a cross-sectional view illustrating a main part of the image forming apparatus with the sheet feeding cassette illustrated in FIG. 3 opened, as viewed from a right surface side in FIG. 3.

FIG. 32 is an enlarged view of a portion surrounded by a circle and indicated by 32 in FIG. 31.

FIG. 33 is a diagram illustrating a state in which a first connecting claw is locked to the receiving portion from the state illustrated in FIG. 32.

FIG. 34 is a diagram illustrating a state in which the slide member is operated to move downward after the state illustrated in FIG. 33.

FIG. 35 is a cross-sectional view illustrating a main part of the image forming apparatus illustrated in FIG. 4 as viewed from the back surface side thereof.

FIG. 36 is an enlarged view of a portion surrounded by a circle and indicated by 36 in FIG. 35.

FIG. 37 is a diagram illustrating a state in which the first connecting claw is locked to the receiving portion from the state illustrated in FIG. 36.

FIG. 38 is a diagram illustrating a state in which the slide member is operated to move downward after the state illustrated in FIG. 37.

FIG. 39 is an enlarged view of a portion surrounded by a circle and indicated by 39 in FIG. 35.

FIG. 40 is a diagram illustrating a state in which the first connecting claw is locked to the receiving portion from the state illustrated in FIG. 39.

FIG. 41 is a diagram illustrating a state in which the slide member is operated to move downward after the state illustrated in FIG. 40.

### DETAILED DESCRIPTION OF THE INVENTION

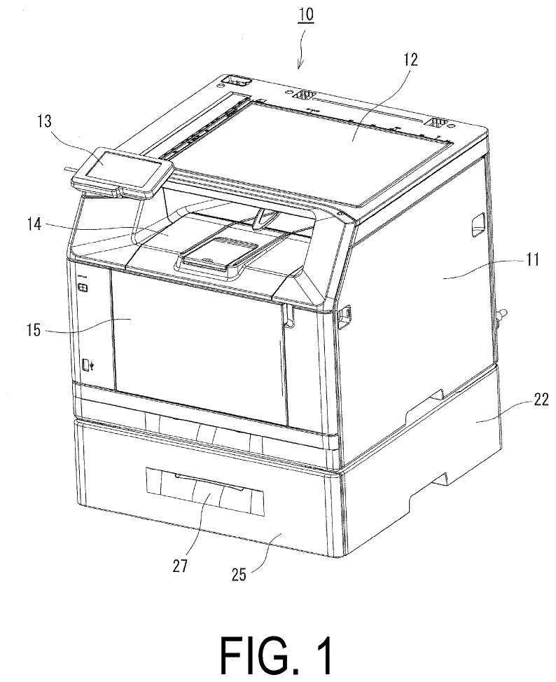

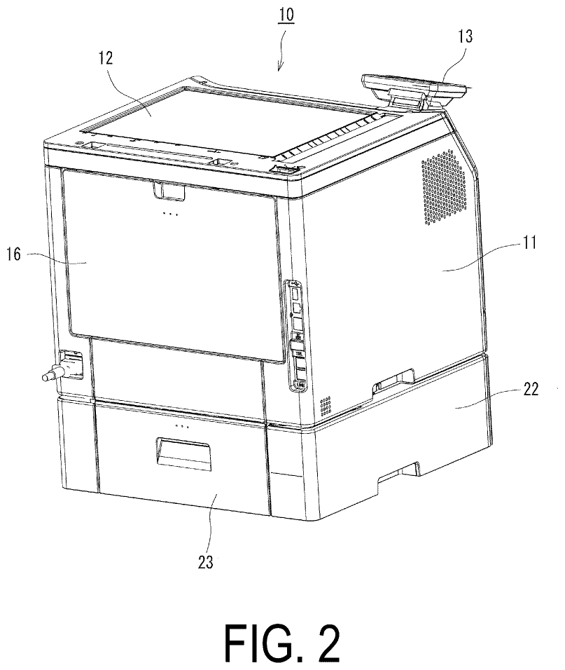

An embodiment according to the present disclosure will be described in detail below with reference to the drawings. FIG. 1 is a perspective view of an image forming apparatus 10 to which an extension unit 22 according to the embodiment of the present disclosure is connected, as viewed from a front surface side, and FIG. 2 is a perspective view of the image forming apparatus 10 illustrated in FIG. 1, as viewed from a back surface side. Referring to FIGS. 1 and 2, the image forming apparatus 10 includes an image forming device body 11 and the extension unit 22 provided so as to be connectable to a lower portion of the image forming device body 11.

The image forming device body 11 includes a document table 12 provided at an upper end for a document (not illustrated) to be placed, an operation panel 13 provided on the front surface side and a left side of the document table 12 so as to be inclined to a near side, a sheet discharge portion 14 that is provided at a lower portion of the document table 12 and from which a printed sheet is discharged, and an opening/closing door 15 provided at a lower portion of the sheet discharge portion 14. An image former (not illustrated) is provided behind the opening/closing door 15. A back door 16 is provided on the back surface side of the image forming device body 11, and the extension unit 22 is provided with an extension unit back surface cover 23.

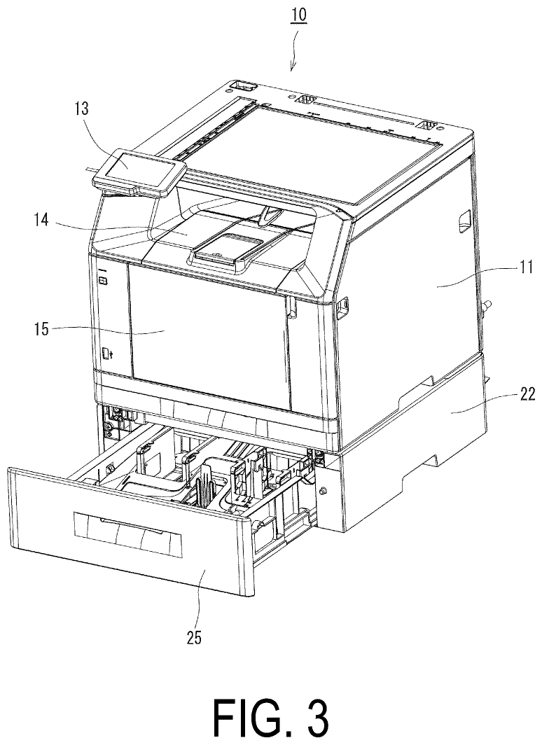

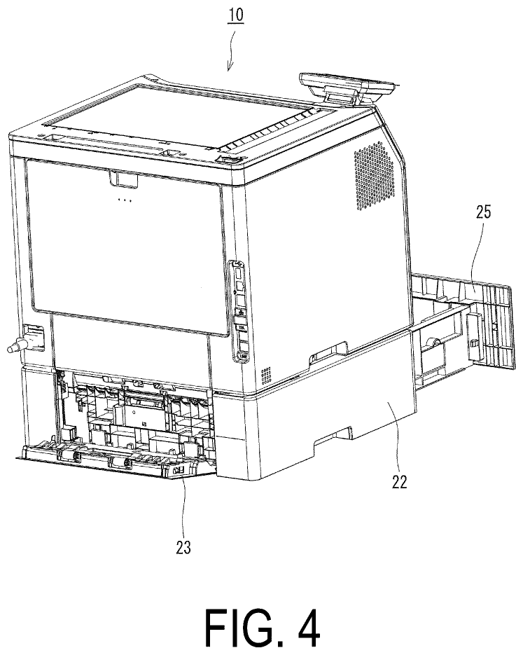

FIG. 3 is a perspective view of a state in which, in the image forming apparatus 10 to which a sheet feeding cassette 25 drawable to the front surface side is connected as the extension unit 22, the sheet feeding cassette 25 is opened, as viewed from the front surface side similarly to FIG. 1, and FIG. 4 is a perspective view of the image forming apparatus 10 illustrated in FIG. 3 as viewed from the back surface side. The extension unit back surface cover 23 provided at a back surface of the extension unit 22 can be opened and closed to and from the back surface side.

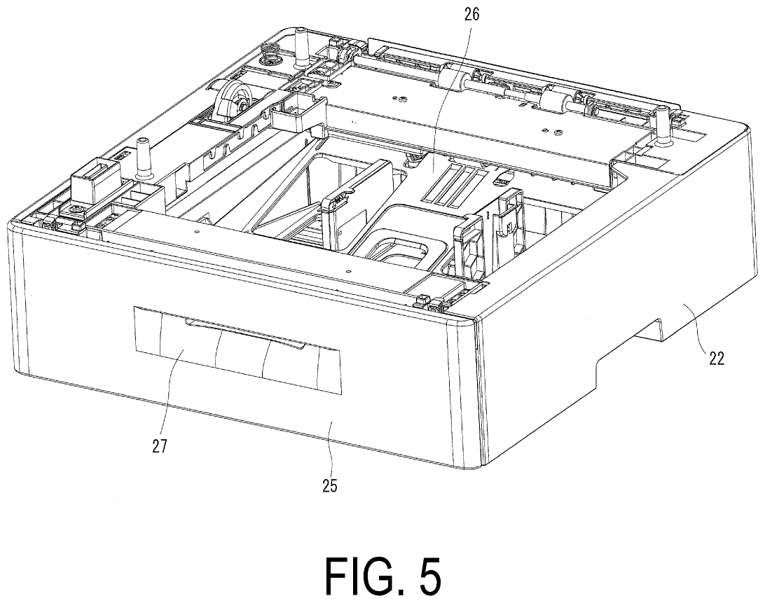

FIG. 5 is a perspective view of the sheet feeding cassette 25 accommodated in the extension unit 22 illustrated in FIG. 3, as viewed from above on the front surface side. Referring to FIG. 5, the sheet feeding cassette 25 includes a sheet holder 26 that accommodates sheets at a center thereof. As illustrated in FIG. 3, the sheet feeding cassette 25 is provided with a drawer portion 27 to draw out the sheet feeding cassette 25 from the front surface side of the extension unit 22.

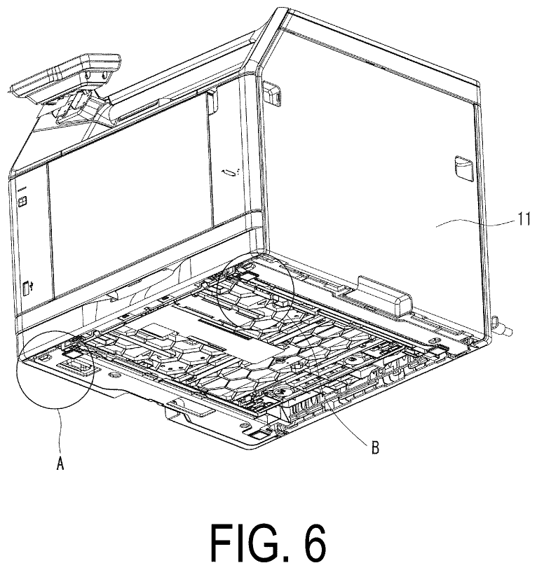

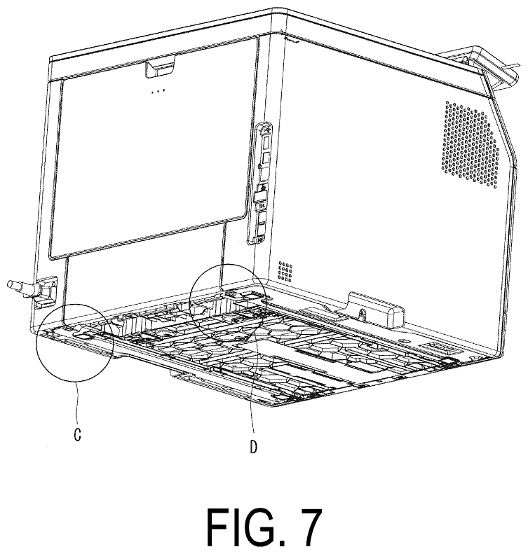

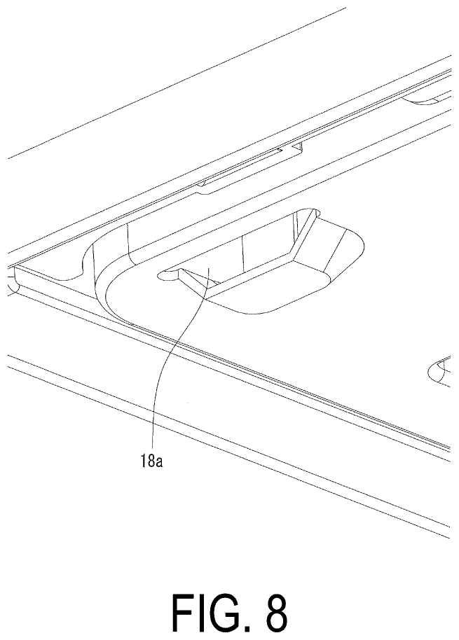

FIG. 6 is a perspective view of the front surface side of the image forming device body 11 illustrated in FIG. 1 as viewed from below, and FIG. 7 is a perspective view of the back surface side of the image forming device body 11 illustrated in FIG. 1 as viewed from below. Referring to FIGS. 6 and 7, a bottom portion of the image forming device body 11 is provided with a mechanism to be locked to an upper portion of the extension unit 22 illustrated in FIG. 5. That is, referring to FIGS. 6 and 7, four corners of the bottom portion of the image forming device body 11 are provided with four locking portions A to D indicated by circles. The four locking portions A to D are illustrated in FIGS. 8 to 11, respectively.

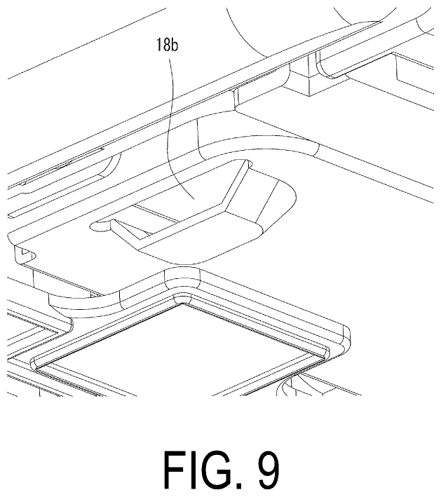

FIG. 8 is an enlarged view of a portion illustrated as the locking portion A in FIG. 6. Referring to FIG. 8, a receiving portion 18a having an inverted trapezoidal shape with a large upper portion and a small lower portion is provided as the locking portion A. FIG. 9 is an enlarged view of a portion illustrated as the locking portion B in FIG. 6. Referring to FIG. 9, a receiving portion 18b having an inverted trapezoidal shape with a large upper portion and a small lower portion is provided as the locking portion B.

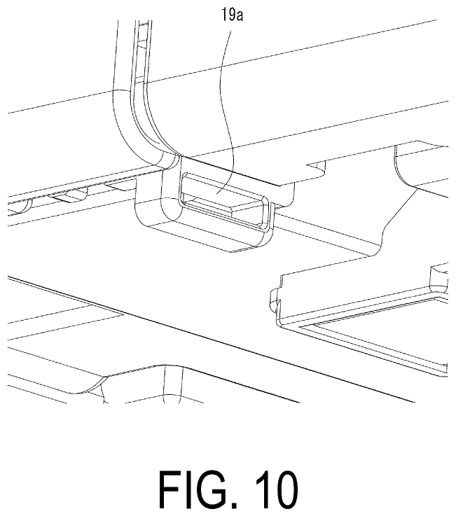

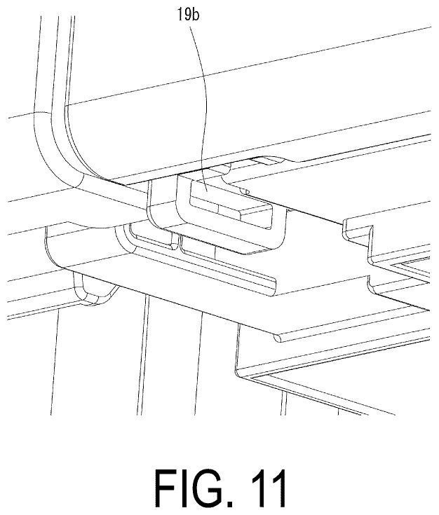

Similarly, FIG. 10 is an enlarged view of a portion illustrated as the locking portion C in FIG. 7, and FIG. 11 is an enlarged view of a portion illustrated as the locking portion D in FIG. 7. Referring to FIGS. 10 and 11, a receiving portion 19a and a receiving portion 19b having a rectangular through hole are provided as the locking portions C and D.

A connecting member described below is inserted into each of the receiving portions 18a, 18b, 19a, and 19b provided at the lower portion of the image forming device body 11, for integration with the extension unit 22.

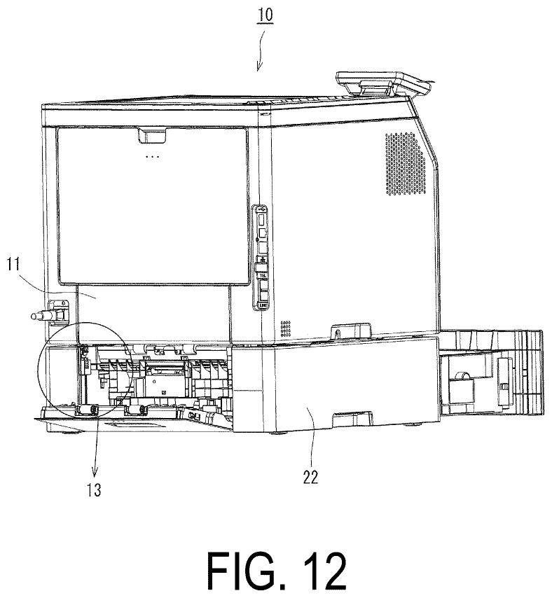

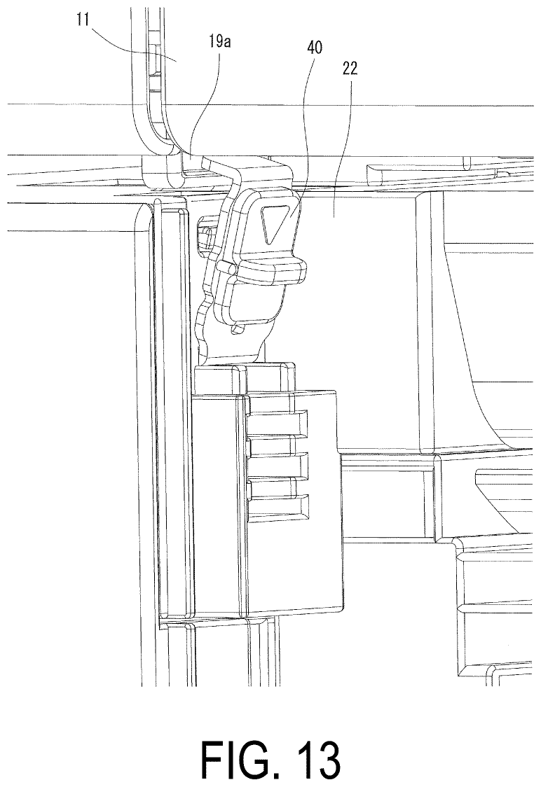

Next, the connecting member will be described. FIG. 12 is a perspective view of the back surface side of the image forming apparatus 10 illustrating a state in which the image forming device body 11 and the extension unit 22 are integrated with each other by the connecting members, and FIG. 13 illustrates an enlarged view of a portion surrounded by a circle and indicated by 13 in FIG. 12. Referring to FIG. 13, a state in which the image forming device body 11 and the extension unit 22 are connected to each other by a connecting member 40 is illustrated.

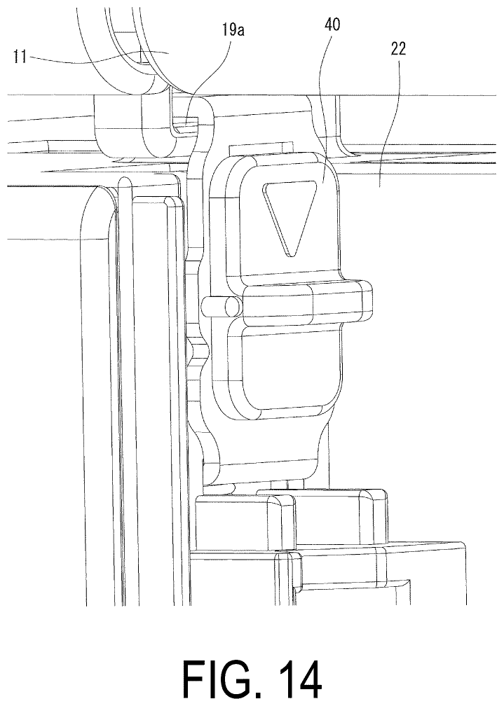

That is, as described below, the connecting member 40 is a U-shaped member including protruding portions that are both upper and lower end portions protruding in one direction, and a state is illustrated here in which the lower end portion is inserted into a predetermined position of the extension unit 22 and the upper end portion is about to be inserted into the predetermined receiving portion 19a of the image forming device body 11. FIG. 14 is a diagram illustrating a state in which the connecting member 40 is inserted into the receiving portion 19a of the image forming device body 11 in FIG. 13, to connect the image forming device body 11 and the extension unit 22 to each other by the connecting member 40, and both are integrated with each other.

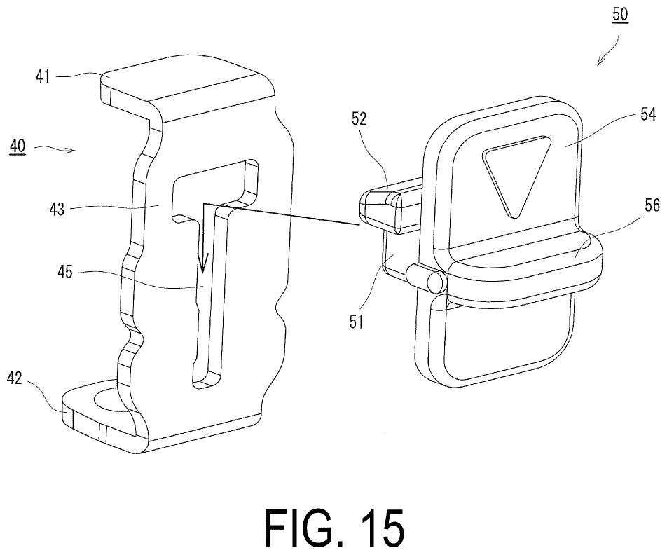

Next, a specific configuration of the connecting member 40 will be described. FIG. 15 is a perspective view illustrating the specific configuration of the connecting member 40. Referring to FIG. 15, the connecting member 40 includes a U-shaped member 43 (note that, seen as an inverted U-shape here), illustrated on a left side of the drawing, including a T-shaped groove 45 at a center, and a slide member 50, illustrated on a right side of the drawing, including a rectangular flat plate 54 long in a vertical direction including a back surface side protruding portion 51 and a front surface side protruding portion 56, the back surface side protruding portion 51 moving as indicated by an arrow in the drawing and allowed to be locked to the T-shaped groove 45 of the U-shaped member 43. Here, the member 50 including the rectangular flat plate 54 long in the vertical direction is referred to as the slide member 50 because, when a T-shaped protruding portion 52 of the back surface side protruding portion 51 is inserted into the T-shaped groove 45 and is integrated with the U-shaped member 43, the slide member 50 can be slid in the vertical direction along the T-shaped groove 45 by a finger hooked on the front surface side protruding portion 56. Note that the U-shaped member 43 is formed in a U-shape since the first connecting claw 41 provided at the upper end portion and the second connecting claw 42 provided at the lower end portion protrude to the same side.

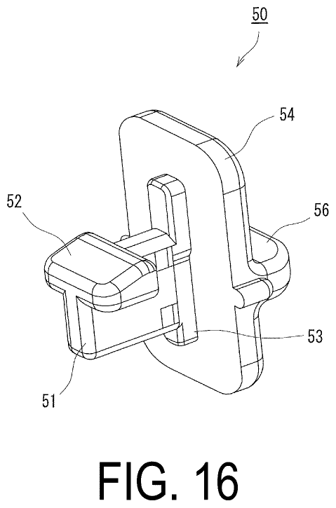

FIG. 16 is a perspective view of the slide member 50 as viewed from the back surface side protruding portion 51 side. Referring to FIG. 16, the back surface side protruding portion 51 can be inserted into the T-shaped groove 45 of the connecting member 40, and includes the protruding portion 52 having a T-shape when the slide member 50 is viewed in the vertical direction, and the T-shaped protruding portion 52 is formed so as to protrude from a raised portion 53 that is raised from the flat plate 54 in a direction of the T-shaped protruding portion 52 throughout the vertical direction. Note that a side of the flat plate 54 opposite to the T-shaped protruding portion 52 is provided with the front surface side protruding portion 56.

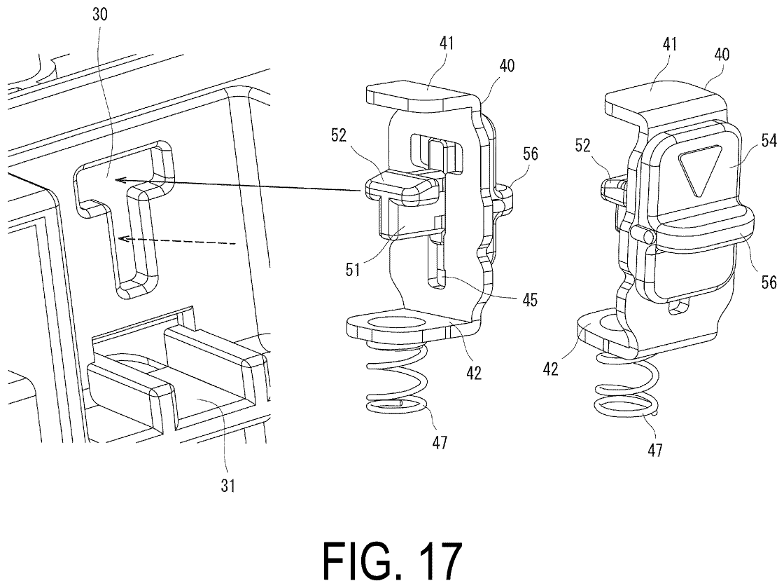

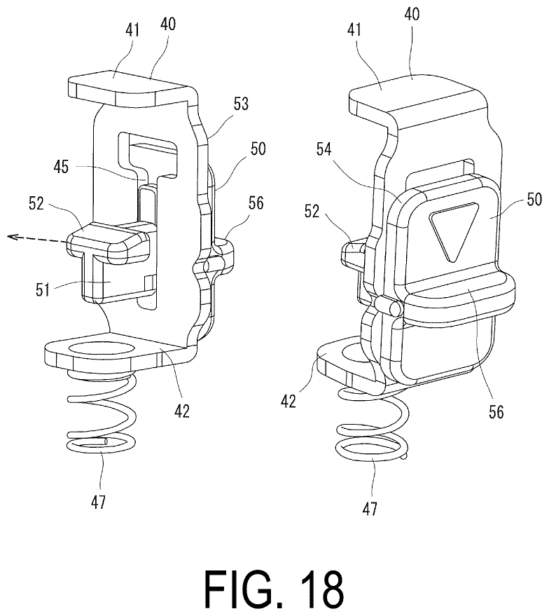

FIG. 17 is a diagram explaining fixing and operation of the connecting member 40. On a left side of FIG. 17, a T-shaped main body hole 30 provided at the image forming device body 11 and the extension unit 22 and a groove 31 provided on a lower side thereof are illustrated, and the connecting member 40 including the T-shaped protruding portion 52 that can be inserted into the main body hole 30 is illustrated at a center. A position where the T-shaped protruding portion 52 of the connecting member 40 illustrated at the center is inserted into the T-shaped main body hole 30 illustrated on the left side of FIG. 17 is indicated by an arrow in the drawing. In addition, at the T-shaped main body hole 30 illustrated on the left side of FIG. 17, an insertion position of the T-shaped protruding portion 52 moved downward, which will be illustrated in FIG. 18 below, is indicated by a dotted line in the drawing.

A perspective view in which the slide member 50 including the front surface side protruding portion 56 of the connecting member 40 is disposed so as to be positioned on a near side is illustrated on a right side of FIG. 17. Here, a lower portion of the connecting member 40 is provided with a biasing member 47, and the biasing member 47 is locked to the groove 31 provided at the main body. This allows the connecting member 40 to be inclined in any direction above the groove 31.

Next, a method of locking or unlocking the connecting member 40 to or from the main body after the state illustrated in FIG. 17 will be described. Here, a case will be described where the second connecting claw 42 of the connecting member 40 is first attached to a predetermined position of the extension unit 22, and then the first connecting claw 41 is attached to the image forming device body 11.

FIG. 18 includes perspective views illustrating a state in which the second connecting claw 42 of the connecting member 40 is locked to the T-shaped main body hole 30, and then the first connecting claw 41 of the connecting member 40 is locked to the image forming device body 11. A state is illustrated on a left side of FIG. 18 in which the back surface side protruding portion 51 is positioned on a lower side of the T-shaped groove 45 in the connecting member 40 than the position illustrated in FIG. 17, and on a right side, a state of the front surface side protruding portion 56 of the slide member 50 in a state of an arrow view illustrated at a right end of FIG. 17 is illustrated.

### First Embodiment

As illustrated in FIG. 18, when the slide member 50 is inserted into the T-shaped groove 45 of the U-shaped member 43, the raised portion 53 of the slide member 50 is guided in the vertical direction along the T-shaped groove 45, and therefore, on a surface of the U-shaped member 43, movement of the slide member 50 in directions other than a groove direction is regulated. Further, when the T-shaped protruding portion 52 is also locked to the main body hole 30, the T-shaped protruding portion 52 regulates movement in a protrusion direction of the T-shaped protruding portion 52. Therefore, the raised portion 53 of the slide member 50 operates as a regulator that regulates displacement in a horizontal direction of the connecting member 40.

Referring to the drawing on the left side of FIG. 17 and the drawing on the left side of FIG. 18, the T-shaped protruding portion 52 is guided downward along the T-shaped groove 45. A position of the T-shaped protruding portion 52 in the main body hole 30 when the T-shaped protruding portion 52 is moved to a lower side of the main body hole 30 is indicated by a dotted line in the drawing on the left side of each of FIGS. 17 and 18. As indicated by the dotted line in the drawing on the left side of FIG. 17, the T-shaped protruding portion 52 is moved to a lower side of the T-shape of the main body hole 30.

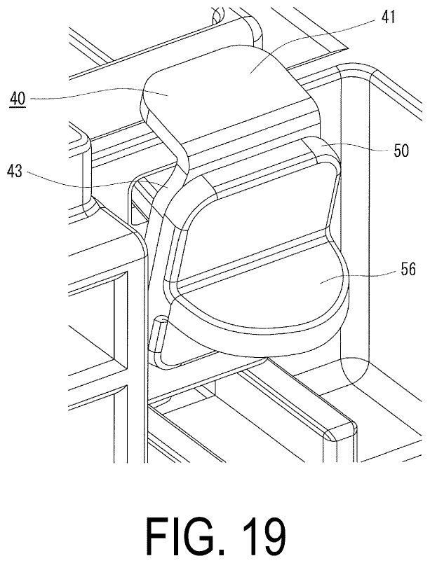

FIG. 19 is a perspective view of the front surface side protruding portion 56 serving as an operation portion of the connecting member 40, as viewed from obliquely above. Referring to FIG. 19, when a user pushes the first connecting claw 41 into the receiving portion 19a of the device main body 11 so as to fit therein and pushes the front surface side protruding portion 56 serving as the operation portion downward, the device main body 11 and the extension unit 22 are kept connected. Conversely, when the connection is released, by pulling the front surface side protruding portion 56 serving as the operation portion upward and releasing the locking between the first connecting claw 41 and the receiving portion 19a of the device main body 11, the connection between the device main body 11 and the extension unit 22 can be released (see FIG. 13).

### Second Embodiment

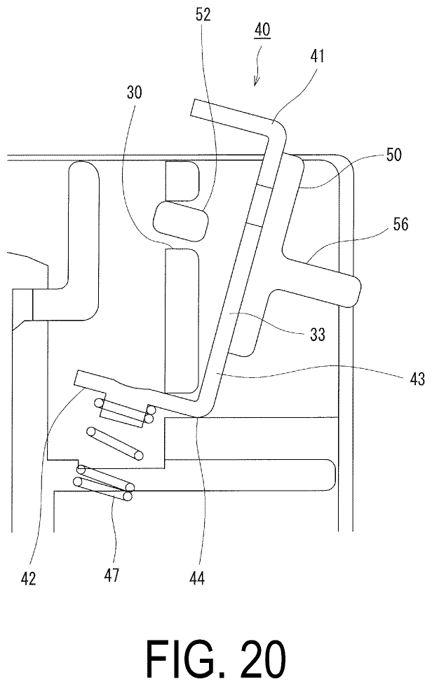

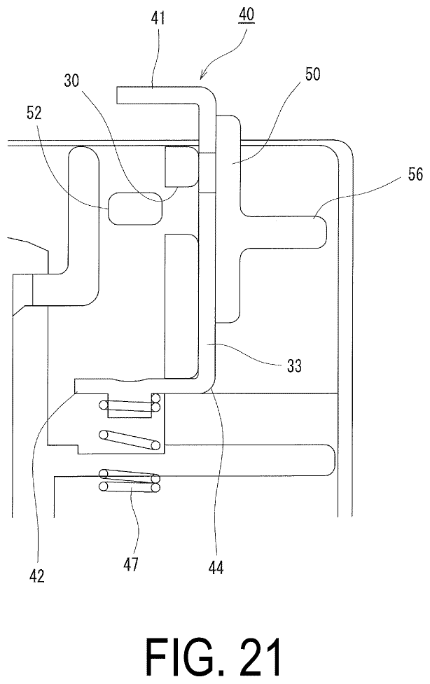

FIG. 20 is a diagram illustrating a state in which the T-shaped protruding portion 52 of the connecting member 40 is inserted into the main body hole 30 of the extension unit 22, and FIG. 21 is a diagram illustrating a state in which the insertion of the T-shaped protruding portion 52 of the connecting member 40 into the main body hole 30 of the extension unit 22 is completed and the connecting member 40 is integrated with the main body. In this state, the connection between the device main body 11 and the extension unit 22 by the connecting member 40 is not locked, and thus the connecting member 40 can be released by the biasing member 47. In order to lock the connection by the connecting member 40, the slide member 50 is to be pushed downward as described below.

Referring to FIGS. 20 and 21, when the T-shaped protruding portion 52 is positioned so as to be allowed to pass through the hole 30 of the device main body 11, the biasing member 47 biases the second connecting claw 42 to be lifted, so that the connecting member 40 can be inclined outward with a corner portion 44, which is a connector with the second connecting claw 42 of the U-shaped member 43, as a fulcrum, to position the first connecting claw at a predetermined position of the image forming device body 11. That is, by operating the front surface side protruding portion 56 that moves the slide member 50 with one finger as a slide lever, operations of connecting and releasing the device main body 11 and the extension unit 22 by the connecting member 40 can be performed.

As a result, as illustrated in FIGS. 17 and 18, by moving the front surface side protruding portion 56 of the slide member 50 serving as the operation portion up and down in a direction in which the first connecting claw 41 and the second connecting claw 42 are connected to each other along the T-shaped groove 45, it is possible to switch between the locked state of the image forming device body 11 and the extension unit 22 where the first connecting claw 41 and the second connecting claw 42 are locked, and the unlocked state.

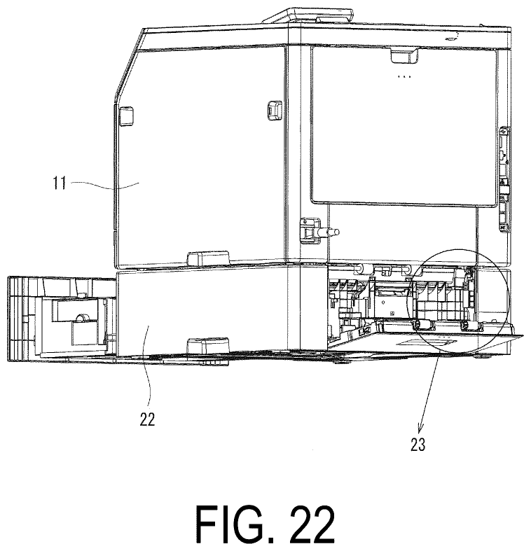

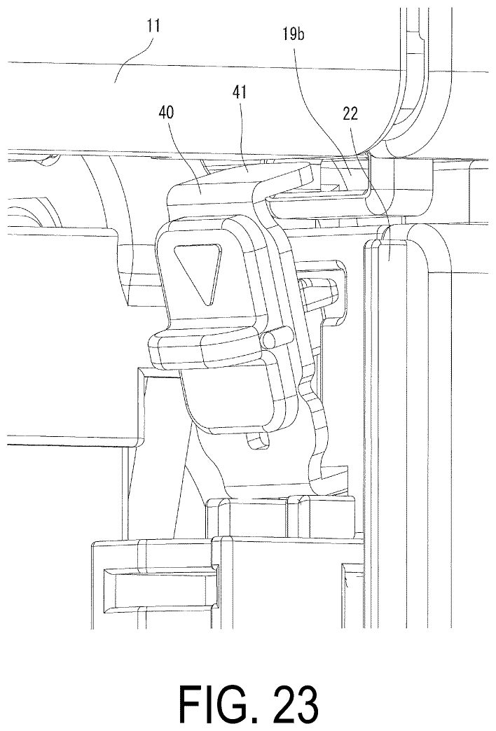

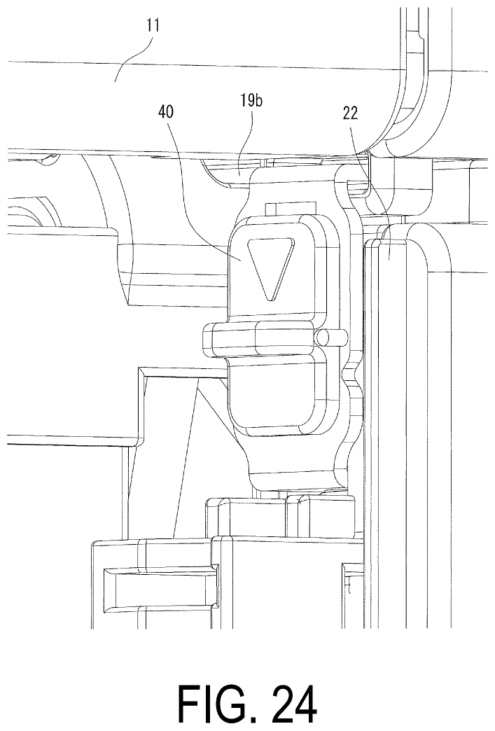

Next, the other connecting members will be described. FIG. 22 is a diagram illustrating a state in which the image forming device body 11 on a side opposite to that in FIG. 12 and the extension unit 22 are integrated with each other by the connecting member, and in FIG. 23, an enlarged view of a portion surrounded by a circle and indicated by 23 in FIG. 22 is illustrated. Referring to FIG. 23, a state is illustrated in which the image forming device body 11 and the extension unit 22 are connected to each other by the connecting member 40 described above. Here again, the second connecting claw 42 at the lower end portion of the connecting member 40 is inserted into a predetermined position of the extension unit 22, and the first connecting claw 41 at the upper end portion is about to be inserted into the predetermined receiving portion 19b of the image forming device body 11. FIG. 24 is a diagram illustrating the state in which the image forming device body 11 and the extension unit 22 are connected to each other by the connecting member 40 and both are integrated with each other.

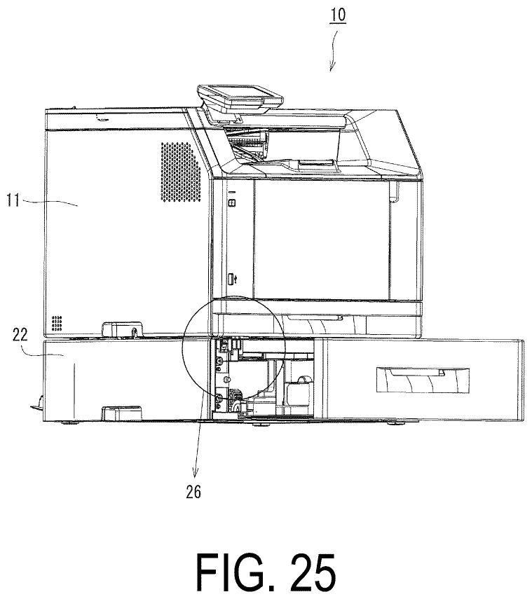

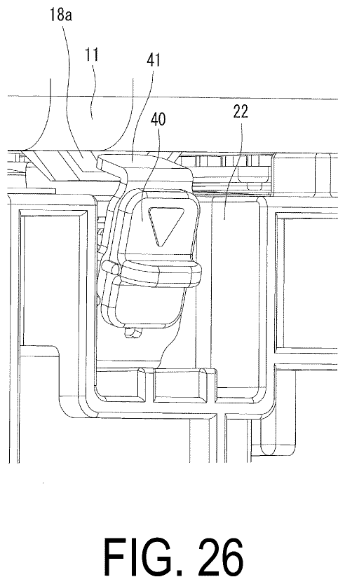

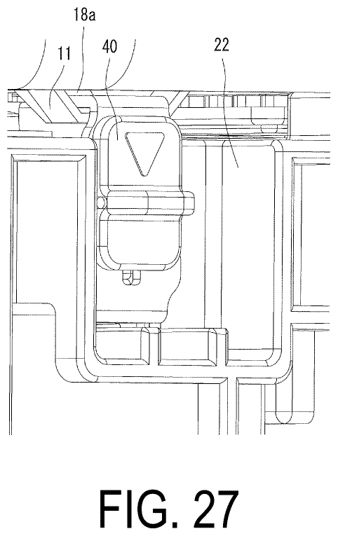

FIGS. 25 to 27 are diagrams illustrating a state in which the image forming device body 11 and the extension unit 22 that are on the front surface side and the left side of the image forming apparatus 10 are integrated with each other by the connecting member 40, and in FIG. 26, an enlarged view of a portion surrounded by a circle and indicated by 26 in FIG. 25 is illustrated. Referring to FIG. 26, the state in which the image forming device body 11 and the extension unit 22 are connected to each other by the connecting member 40 is illustrated. Here again, the lower end portion is inserted into a predetermined position of the extension unit 22, and the first connecting claw 41 at the upper end portion is about to be inserted into the predetermined receiving portion 18a of the image forming device body 11. FIG. 27 illustrates the state in which the image forming device body 11 and the extension unit 22 are connected to each other by the connecting member 40 and both are integrated with each other.

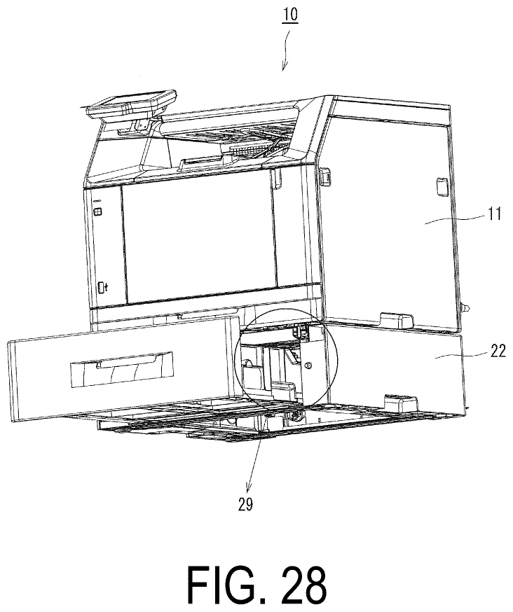

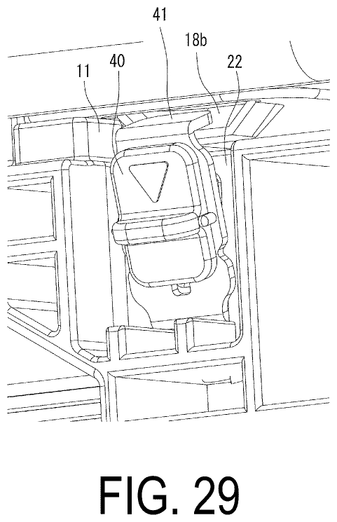

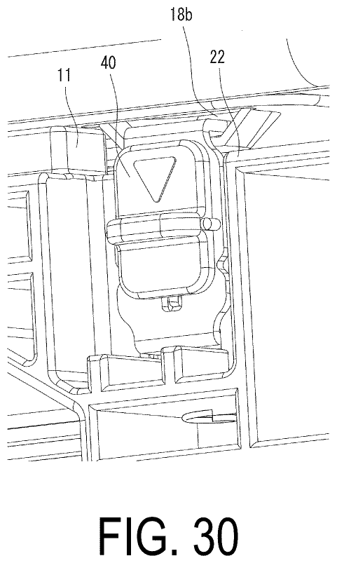

Similarly, FIGS. 28 to 30 are diagrams illustrating a state in which the image forming device body 11 and the extension unit 22 that are on the front surface side and the right side of the image forming apparatus 10 are integrated with each other by the connecting member 40. In FIG. 29, an enlarged view of a portion surrounded by a circle and indicated by 29 in FIG. 28 is illustrated. Referring to FIG. 29, the state in which the image forming device body 11 and the extension unit 22 are connected to each other by the connecting member 40 is illustrated. Here again, the lower end portion is inserted into a predetermined position of the extension unit 22, and the first connecting claw 41 at the upper end portion is about to be inserted into the predetermined receiving portion 18b of the image forming device body 11. FIG. 30 illustrates a state in which the image forming device body 11 and the extension unit 22 that are on the front surface side and the right side of the image forming apparatus 10 are integrated with each other by the connecting member 40.

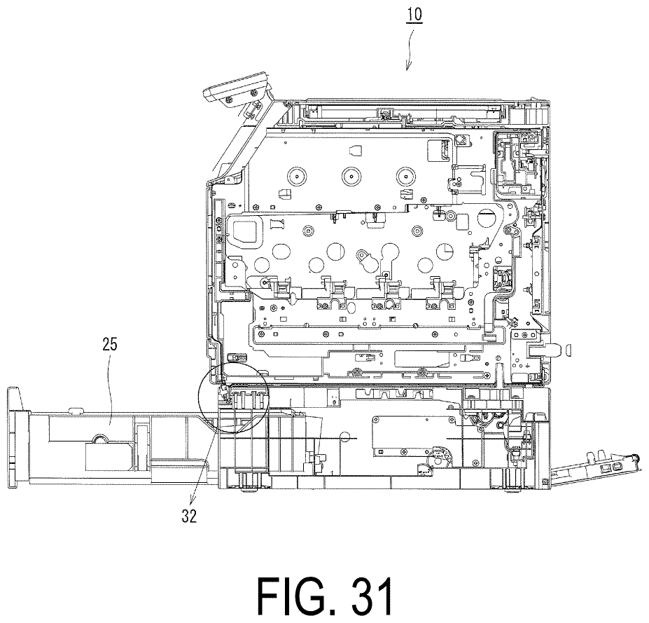

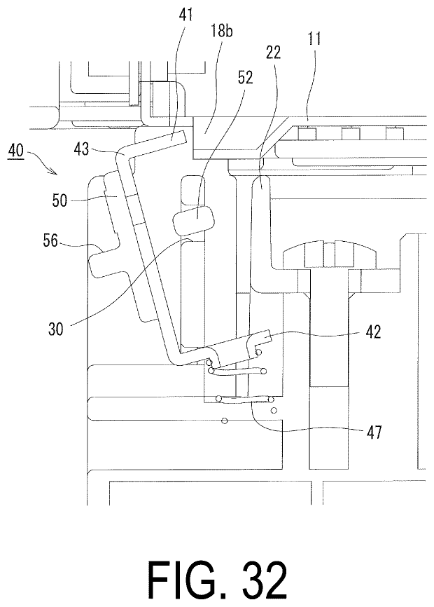

Next, a state in which the above-described four connecting members 40 are connected will be described as viewed from another angle. FIG. 31 is a cross-sectional view illustrating a main part of the image forming apparatus 10 with the sheet feeding cassette 25 illustrated in FIG. 3 in an open state, as viewed from a right surface side in FIG. 3, and in FIG. 32, an enlarged view of a portion surrounded by a circled and indicated by 32 in FIG. 31 is illustrated. This portion corresponds to the connecting member 40 illustrated in FIGS. 28 to 30. While FIGS. 28 to 30 illustrate the state of the connecting member 40 with the slide member 50 facing the front, in the drawings here, the connecting member 40 is viewed in an orthogonal direction (direction in which the U-shape is visible), and a state in which the first connecting claw 41 is locked to the receiving portion 18b illustrated in FIG. 8 after the second connecting claw 42 is fixed at a predetermined position by the biasing member 47.

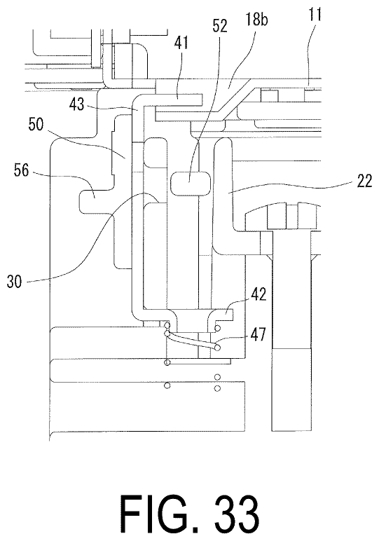

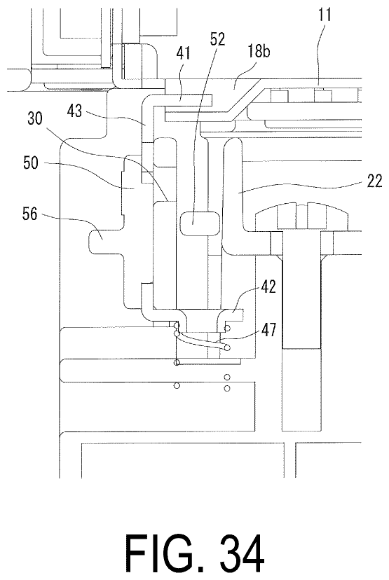

FIGS. 33 and 34 are diagrams respectively illustrating a state in which the first connecting claw 41 is locked to the receiving portion 18b from the state of FIG. 32, and a state in which, subsequently, the slide member 50 is operated to move downward and the slide member 50 is moved to a lower side of the T-shaped groove 45 as illustrated in FIG. 18. These drawings correspond to the drawings illustrated in FIGS. 20 and 21 described above as viewed from an opposite direction. As illustrated in FIGS. 32 to 34, after the T-shaped protruding portion 52 is passed through a head portion of the T-shape of the main body hole 30 and the first connecting claw 41 is locked to the receiving portion 18b, the front surface side protruding portion 56 is moved downward, so that the T-shaped protruding portion 52 is moved to the lower side of the main body hole 30 and the extension unit 22 is locked by the connecting member 40.

That is, by operating the front surface side protruding portion 56, when the T-shaped protruding portion 52 is positioned so as to pass through the main body hole 30 as illustrated in FIGS. 32 and 33, the T-shaped protruding portion 52 is positioned so as to come out of the main body hole 30, and when the T-shaped protruding portion 52 is positioned below the main body hole 30 as illustrated in FIG. 34, the T-shaped protruding portion 52 does not come out of the main body hole 30.

As described above, the slide member 50 includes the front surface side protruding portion 56 that operates as the operation portion that switches between the locked state and the unlocked state of at least one of the first connecting claw 41 and the second connecting claw 42, and the operation portion can be operated in the direction in which the first connecting claw 41 and the second connecting claw 42 are connected to each other along the connecting member 40.

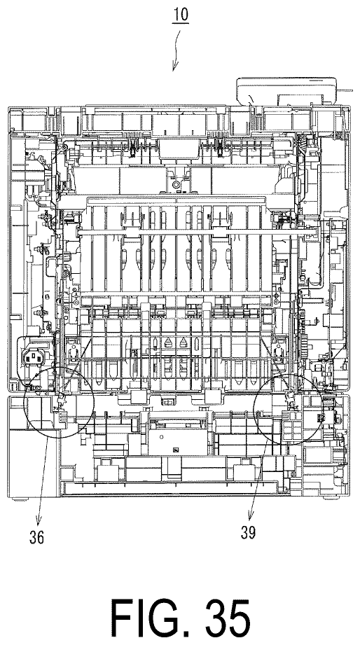

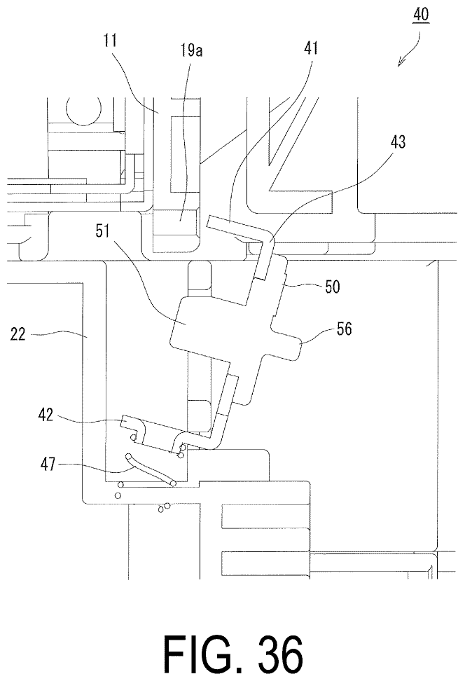

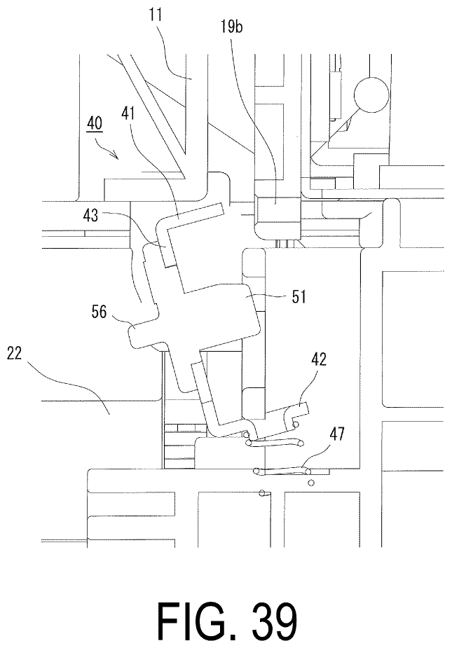

FIG. 35 is a cross-sectional view illustrating a main part of the image forming apparatus 10 illustrated in FIG. 4 as viewed from the back surface side, and in FIGS. 36 and 39, enlarged views of 36 and 39 each surrounded by a circle in FIG. 35 are illustrated. These portions are drawings corresponding to the connecting member 40 illustrated in FIGS. 12 to 14 and FIGS. 22 to 24, and FIGS. 12 to 24 illustrate the state of the connecting member 40 with the slide member 50 facing the front, whereas in these drawings, the connecting member 40 is viewed in an orthogonal direction (direction in which the U-shape is visible).

Referring to FIG. 36, here, a state is illustrated in which, after the second connecting claw 42 is fixed at a predetermined position of the extension unit 22 by the biasing member 47, the entire connecting member 40 is inclined and the first connecting claw 41 is locked to the receiving portion 19a at a rear portion illustrated in FIG. 12.

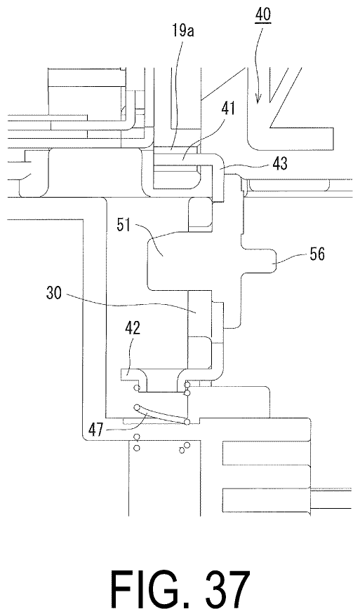

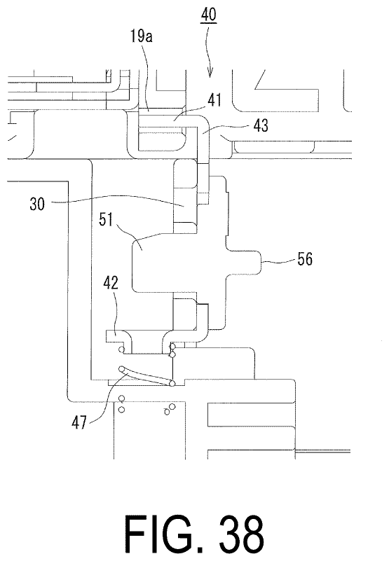

FIGS. 37 and 38 are diagrams respectively illustrating a state in which the first connecting claw 41 is locked to the receiving portion 19a from the state of FIG. 36, and a state in which, subsequently, the slide member 50 is operated to move downward and the slide member 50 is moved to the lower side of the T-shaped groove 45 as illustrated in FIG. 18.

Next, an opposite side will be described. FIG. 39 is an enlarged view of a portion surrounded by a circle and indicated by 39 in FIG. 35. Referring to FIG. 39, here, a state is illustrated in which, after the second connecting claw 42 is fixed at a predetermined position of the extension unit 22 by the biasing member 47, the entire connecting member 40 is inclined and the first connecting claw 41 is locked to the receiving portion 19b at the rear portion of the image forming device body 11 illustrated in FIG. 22.

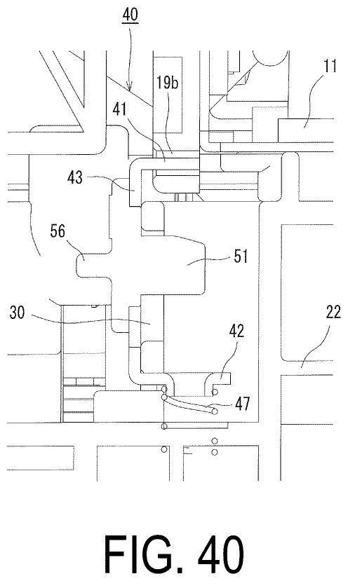

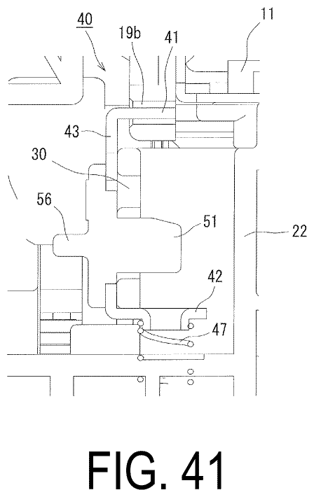

FIGS. 40 and 41 are diagrams respectively illustrating a state in which the first connecting claw 41 is locked to the receiving portion 19b from the state of FIG. 39, and a state in which, subsequently, the slide member 50 is operated to move downward and the slide member 50 is moved to the lower side of the T-shaped groove 45.

Note that in the above embodiments, the case where the second connecting claw of the connecting member is first attached to the extension unit, and then the first connecting claw is attached to the image forming device body to integrate the extension unit and the image forming device body with each other has been described, but the present disclosure is not limited thereto, and the first connecting claw of the connecting member may be first provided at the image forming device body and then the second connecting claw may be attached to the extension unit.

The present disclosure may be carried out in other various forms without departing from the spirit or essential characteristics thereof. Thus, the above embodiments are merely examples and should not be interpreted as limiting. All modifications and changes equivalent in scope with the claims of the present disclosure are included in the scope of the present disclosure.

### INDUSTRIAL APPLICABILITY

According to the present disclosure, it is possible to provide an image forming apparatus to which an extension unit can be connected using a connecting member having a compact configuration with fewer members, and thus the present disclosure is useful as an image forming apparatus.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus, comprising:
a connecting member that connects, in an image forming device body and an extension unit allowed to be connected below the image forming device body, the image forming device body and the extension unit to each other, wherein
the connecting member includes a first connecting claw that is locked to the image forming device body, and a second connecting claw that is locked to the extension unit, and
includes an operation portion that switches between a locked state and an unlocked state of at least one of the first connecting claw and the second connecting claw, and
the operation portion is operable in a direction in which the first connecting claw and the second connecting claw are connected to each other along the connecting member.

2. The image forming apparatus according to claim 1, wherein
the operation portion includes a regulator that regulates displacement in a horizontal direction of the connecting member, and regulates the displacement in the horizontal direction of the connecting member in a state in which the connecting member connects the image forming device body and the extension unit to each other, and the regulation in the horizontal direction of the connecting member by the operation portion is released in a state in which the connection is released.

3. The image forming apparatus according to claim 1, wherein
the extension unit is integrated with the image forming device body by,
positioning the second connecting claw of the connecting member at a predetermined position of the extension unit,
inclining, in a state in which a back surface side protruding portion of the connecting member is inserted into an opening of the extension unit, the connecting member outward with a corner portion of the connecting member as a fulcrum,
disposing the first connecting claw to be locked at a predetermined position of the image forming device body, and
then pushing the operation portion downward.

4. The image forming apparatus according to claim 1, the image forming apparatus comprising a plurality of the connecting members.

5. The image forming apparatus according to claim 1, wherein
the connecting member is attached to the extension unit, and then attached to the image forming device body.
